(19) United States
(12) Patent Application Publication
(10) Pub. No.: US 2004/0139198 A1
(43) Pub. Date: Jul. 15, 2004

(54) Method and apparatus for manipulating data with session initiation protocol

(76) Inventors: Jose Costa-Requena, Helsinki (FI); Tao Haukka, Oulu (FI); Aki Niemi, Helsinki (FI); Markus Isomaki, Espoo (FI); Eva-Maria Leppanen, Tampere (FI); Mikko Lonnfors, Helsinki (FI); Juha Kalliokulju, Vesilahti (FI); Krisztian Kiss, Tampere (FI)

Correspondence Address: Crawford Maunu PLLC, 1270 Northland Drive, Suite 390, St. Paul, MN, 55120, US

(21) Appl. No.: 10/345,114

(22) Filed: Jan. 15, 2003

(51) Int. Cl. G06F 15/16

(52) U.S. Cl. 709/227

(57) ABSTRACT

A method and apparatus for updating authorization and other persistent data using the session initiation protocol. In one aspect, a computing device sends a SIP PUBLISH message (or any other appropriate SIP message) to a second networked computing device. The second device extracts data from the SIP message and uses the extracted data to modify and/or update a set of persistent data. The data may be placed in the body of the SIP message. In one example, the SIP message body uses XML enclosing a remote procedure call or a call processing script.

### FIELD OF THE INVENTION

This invention relates in general to computing and communications devices, and more particularly to a method and apparatus for manipulating data using the session initiation protocol.

### BACKGROUND OF THE INVENTION

Personal communication devices are becoming more widely adopted by the public. Such devices as cellular phones, personal digital assistants, and laptop computers give users a variety of mobile communications and computer networking capabilities. Implementing digital connectivity for mobile devices gives rise to technical challenges not seen in traditional computer networks.

One complication with mobile computing devices is finding other users for establishing peer-to-peer communications. Such applications as voice over IP (VoIP) and instant messaging require locating devices used by others. Traditional TCP/IP methods of finding computing devices such as hostname lookup fall short considering that mobile devices may freely move between various types of networks.

One way of solving this problem is to have users access a centralized system that provides peer-to-peer services. However, this locks users into competing (and typically incompatible) service providers. Further, such services are typically web based, meaning they don't work as effectively on low-power, low-bandwidth devices such as cellular telephones.

An alternate to centralized services is having an open peer-to-peer connectivity standard usable by a wide variety of devices. One issue in using such a system is maintaining persistent system data on servers needed for locating users and defining policies for contacting the users. For example, an access list may be needed at a server to allow desired communications and block unwanted communications. It would be inefficient to keep the list on the mobile device due to the typically low bandwidth connections used by such devices. If connection attempts were blocked at the user's device instead of a server, a situation might arise where numerous unwanted connection attempts would tie up the limited resources of the remote data link.

What is needed is a way to add, maintain and delete persistent data on a server or other remote computing device. Further, such functionality should be able to run on numerous networks and allow remote data manipulation even when data links are changed in the middle of a session or the user communicates using multiple devices. The present invention addresses these and other needs, and offers other advantages over prior art approaches.

### SUMMARY OF THE INVENTION

To overcome limitations in the prior art described above, and to overcome other limitations that will become apparent upon reading and understanding the present specification, the present invention discloses a method and apparatus for manipulating data on a remote data processing device using a session initiation protocol.

In one embodiment of the present invention, a method for manipulating an authorization data on a remote data processing device involves preparing a modification data on a local data processing device. The modification data is sent to the remote data processing device using a session initiation protocol. The authorization data is modified with the modification data on the remote data processing device.

Preparing the modification data on the local data processing device and sending it to the remote data processing device may involve using one or more of the PUBLISH, DO, and/or PUT methods of the session initiation protocol (SIP). The modification data and the functionality that the remote data processing device should perform on the received data may be described by using one or more SIP header entries (i.e. generic headers such as; Event, Content-Disposition, and other specific headers for data flow manipulation such as Class, Stream, etc.).

In one aspect of the method, the modification data is formatted as extensible markup language (XML). The modification data may also be formatted as one or more of call processing language (CPL), application configuration access protocol (ACAP) and simple object access protocol (SOAP) language. The authorization data may include one or more of presence access data, access lists, membership lists, and an access policy (e.g. access rules based on characteristics of a user identity).

In another embodiment of the present invention, a data processing system includes a storage device containing a persistent authorization data and a network interface configured to communicate with a remote data processing device. A processor is arranged to receive a message from remote data processing device over the network interface using a session initiation protocol and extract a modification data from the message. The processor is further configured to modify the authorization data using the modification data and according to the functionality indicated in the SIP headers.

The message may include one or more of the PUBLISH, DO, and PUT methods of SIP. The processor may be configured to modify the authorization data based on one or more SIP header entries (Event, Content-Disposition, and other specific headers such as Class, Stream, etc) of the message. The replacement data may be formatted as one or more of XML, CPL, ACAP, and SOAP languages.

The authorization data may include one or more of a presence access data, access lists, membership lists, access policy. The network interface may include a wireless interface and the remote data processing device may include a wireless telephone and/or a personal digital assistant (PDA).

In another embodiment of the present invention, a method for manipulating an authorization data on a remote data processing device involves preparing a session initiation protocol formatted message on a local processing device. The message includes a modification data in a message body and the data modification functionality in the SIP message headers. The message is sent to the remote data processing device using a session initiation protocol. A content header of the message is examined at the remote data processing device to determine the contents of the message body. The message body is processed based on the content header to extract the modification data from the message body and the authorization data is modified with the modification data based on the processing data functionality indicated in the SIP headers.

The above summary of the present invention is not intended to describe each illustrated embodiment or implementation of the present invention. This is the purpose of the figures and the associated discussion which follows.

### BRIEF DESCRIPTION OF THE DRAWINGS

The invention is described in connection with the embodiments illustrated in the following diagrams.

FIG. 1 illustrates a representative system environment in which the principles of the present invention may be employed;

FIG. 2 is a diagram of a SIP message being send to a server to update persistent data according to concepts of the present invention;

FIG. 3 is a diagram of a SIP message used to update authorization data on an authorization server according to concepts of the present invention;

FIG. 4 is a message flow diagram showing one scenario of updating persistent data according to concepts of the present invention; and

FIG. 5 is a diagram of a SIP message illustrating a message body according to one aspect of the present invention.

### DETAILED DESCRIPTION OF THE INVENTION

In the following description of the exemplary embodiment, reference is made to the accompanying drawings which form a part hereof, and in which is shown by way of illustration various manners in which the invention may be practiced. It is to be understood that other embodiments may be utilized, as structural and operational changes may be made without departing from the scope of the present invention.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

Generally, the present invention provides a method and apparatus for remotely updating persistent data on a data processing equipment using an unreliable, event-based signal protocol. In one aspect of the present invention, a session initiation protocol can be used to modify persistent data. A session initiation protocol as used herein generally refers to any general purpose protocol that negotiates data sessions between devices. A currently defined instantiation of a session initiation protocol has been defined Internet Engineering Task Force (IETF), and is herein referred to as “SIP”. SIP is standard signaling protocol that operates on the application layer of the Open Systems Interconnection (OSI) networking model. Although the present invention is described in terms of SIP, it is appreciated that concepts according to the present invention can be implemented using any form of session initiation protocol, and use of SIP as defined by IETF is for purposes of illustration.

The primary purpose of session protocols such as SIP is to establish sessions that allow simple end-to-end data transfers between networked devices. As will be described further herein, SIP can also be used for transferring data between one or more network endpoints. One or more of the endpoints may be mobile, e.g. moving from location to location and from network to network. Mobile endpoints include all manner of digital communication devices.

In general, digital communication devices are electronic apparatuses that can exchange data with other devices. The data can be transmitted through various communication mediums such as wire, optical fiber, or through the air as electromagnetic or light waves. Increasingly, communication devices include some sort of computing hardware such as a microprocessor. The growth of microprocessor controlled devices has been steadily growing in the field of mobile communication devices (cellular phones, PDAs, etc.). By and large, most mobile communications devices use microprocessors and can therefore be considered mobile data processing devices.

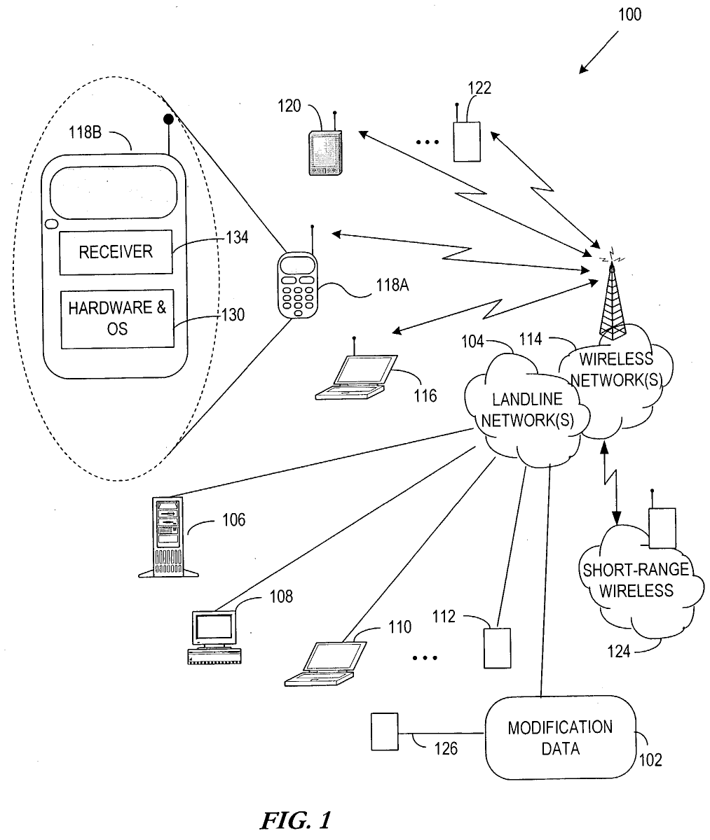

FIG. 1 illustrates a representative system environment 100 in which the principles of the present invention may be employed. In the representative system environment 100, modification data 102 may be provided to target devices in any number of known manners. These manners include via a landline network(s) 104, which may include a Global Area Network (GAN) such as the Internet, one or more Wide Area Networks (WAN), Local Area Networks (LAN), and the like. Any computing device or other electronic device that supports modification data 102 may be the target system that utilizes the present invention, such as servers 106, desktop computers 108 or workstations, laptop or other portable computers 110, or any other similar computing device capable of communicating via the network 104, as represented by generic device 112.

The data 102 may be provided via one or more wireless networks 114, such as Global System for Mobile Communications (GSM), Universal Mobile Telecommunications System (UMTS), Personal Communications Service (PCS), Time Division Multiple Access (TDMA), Code Division Multiple Access (CDMA), or other mobile network transmission technology. Again, any mobile electronic device that can be used to modify data that can interface with a target system that utilizes concepts according to the present invention, such as laptop or other portable computers 116, mobile phones 118A and other mobile communicators, Personal Digital Assistants (PDA) 120, or any other similar computing device capable of communicating via the wireless network 114, as represented by generic device 122.

The data 102 may be transferred between devices using short-range wireless technologies 124, such as Bluetooth, Wireless Local Area Network (WLAN), infrared (IR), etc. The data 102 can also be distributed using direct wired connections, such as depicted by connection path 126. The present invention is applicable regardless of the manner in which data 102 is provided or distributed between the target devices.

An example of a target device that utilizes concepts according to the present invention is illustrated as the mobile phone 118B. The device 118B includes, for example, a radio transceiver 134 and hardware (including the processor) coupled to an operating system (OS) 130. The present invention may be implemented as firmware or as a program running on the OS 130.

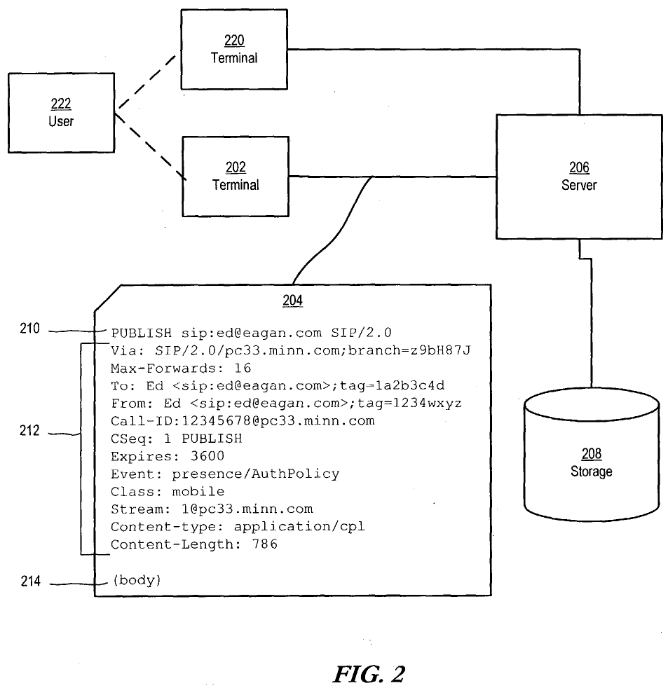

FIG. 2 is a diagram showing a simple transaction using SIP to update persistent data. In this example, a terminal 202 is sending a SIP message 204 to a server 206. A data storage device 208 is coupled to the server 206 for storage of persistent data. The SIP message 204 is received at the server 206 and used to update or modify persistent data in the storage device 208.

When sending the SIP formatted message, the terminal 202 is acting as a user agent client (UAC) and the server 204 is acting as a user agent server (UAS). The designations UAC and UAS can be used interchangeably between the terminal 202 and server 204. In general, the designation of UAC and UAS are only used to denote the sender of a SIP request (i.e. the UAC) and the receiver of the SIP request (i.e. the UAS). Therefore, it is appreciated that concepts according to the present invention are equally applicable to update persistent data stored on the terminal 202 by a message sent from the server 206.

A second terminal 220 may be associated with the user 222 of the terminal 204 and is also in communication with the server 204 in FIG. 2. It is appreciated that a single user 222 may have multiple data devices in use at the same time. The user 222 may wish share system state data between the devices. SIP allows for certain transactions to reflect the state of multiple data devices. An example of this is when dealing with presence data. Presence data is data that describes the willingness and ability of the user to be contacted by others on the network. Presence can be communicated and maintained using various types of SIP messages.

The example SIP message 204 shown in FIG. 2 includes a text portion containing a start-line 210 followed by a header 212. The message 204 may also contain a body 214. Both start-line 210 and header 212 are formatted according to the SIP specification. The current specification for SIP is described in IETF RFC3261, “SIP: Session Initiation Protocol”. The start line contains a method string, which identifies the general class of the message. In the example of FIG. 2, the SIP method used is PUBLISH, which is described in various IETF drafts. A recent IETF draft that describes PUBLISH is draft-olson-simple-publish.txt, “SIMPLE Presence Publication Mechanism”. In general terms, PUBLISH is used to send out some sort of data to interested users on the network.

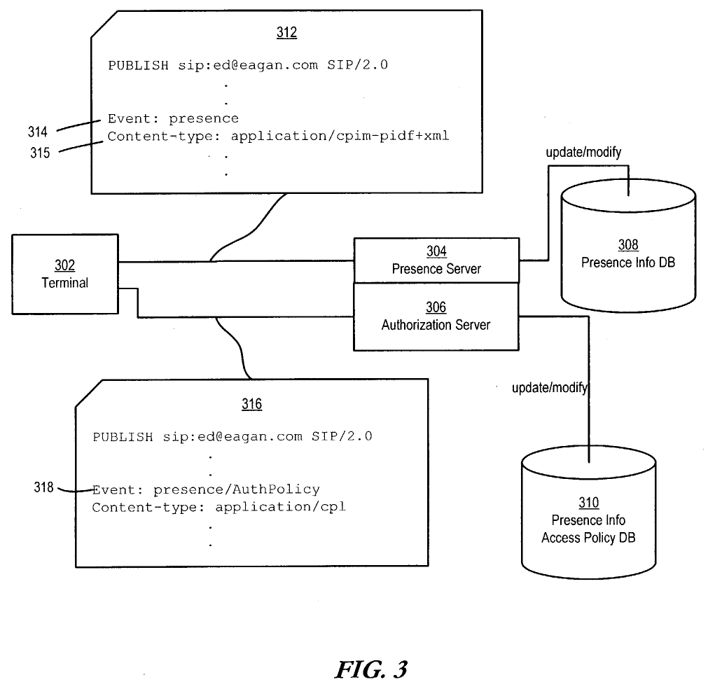

FIG. 3 shows a PUBLISH method being used to update/modify persistent data. In particular, the data updated in FIG. 3 is presence data and presence authorization data. A terminal 302 is networked with a presence server 304 and an authorization server 306. The servers 304, 306 may be separate physical entities or may be arranged as separate logical entities running on the same device and/or process. The presence server 304 and the authorization server 306 are coupled to a presence database 308 and an authorization database 310. A SIP message such as 204 in FIG. 2 can include “Authorization” headers to include authentication and authorization information to allow the data manipulation. The databases 308 and 310 may be separate logical or physical entities.

The terminal 302 of FIG. 3 updates presence data by sending a SIP message 312 to the presence server 304. In this example, the presence content of the message is indicated by the “Event” header field 314 and the message format is indicated by the “Content-Type” header 315. The presence server 304 uses this data to update and/or modify presence data in the presence database 308. The SIP message 316 is for modifying authorization data and is sent to the authorization server 306. This is indicated by the “Event” header field 318. In the event that additional functionality is required at the remote processing data then other SIP specific headers used for data flow manipulation such as “Stream” and “Class” could be added to differentiate multiple terminals and data streams. A “Content-Disposition” header with a new set of values (“remove”, “merge”, etc) can be also included to add further functionality to the processing data in the remote device. The SIP message 316 is used by the authorization server 306, after checking the authentication/authorization credentials included in “Authorization” header to update and/or modify the authorization database 310.

In the examples of FIGS. 2 and 3, the SIP PUBLISH method is used. PUBLISH can send event data to multiple recipients and can do so without requiring that a state be maintained for the event. Other SIP methods may be used for this purpose, including as REGISTER, DO, PUT and SUBSCRIBE/NOTIFY. Therefore use of the PUBLISH method is for purposes of illustration and not of limitation. Regardless, the PUBLISH method has advantages in some cases over methods such as REGISTER and SUBSCRIBE/NOTIFY.

The REGISTER method does not allow forking of requests. The REGISTER method is typically described in terms of binding a SIP Uniform Resource Identifier (URI) with a user agent. The REGISTER requests are sent to a single server or event agent (e.g. the registrar) to handle the request. When modifying presence data or presence authorization data, it is appreciated that there may be more than one event agent that is interested in the request.

The SUBSCRIBE/NOTIFY method can be used to change an event state to more than one event agent. Therefore, SUBSCRIBE/NOTIFY is also applicable to changing persistent data. However, the use of SUBSCRIBE/NOTIFY maintains a state (also known as a SIP dialog) between various subscribers and notifiers. This maintenance of state has some advantages, but also tends to make implementation more complicated and to consume more communications bandwidth.

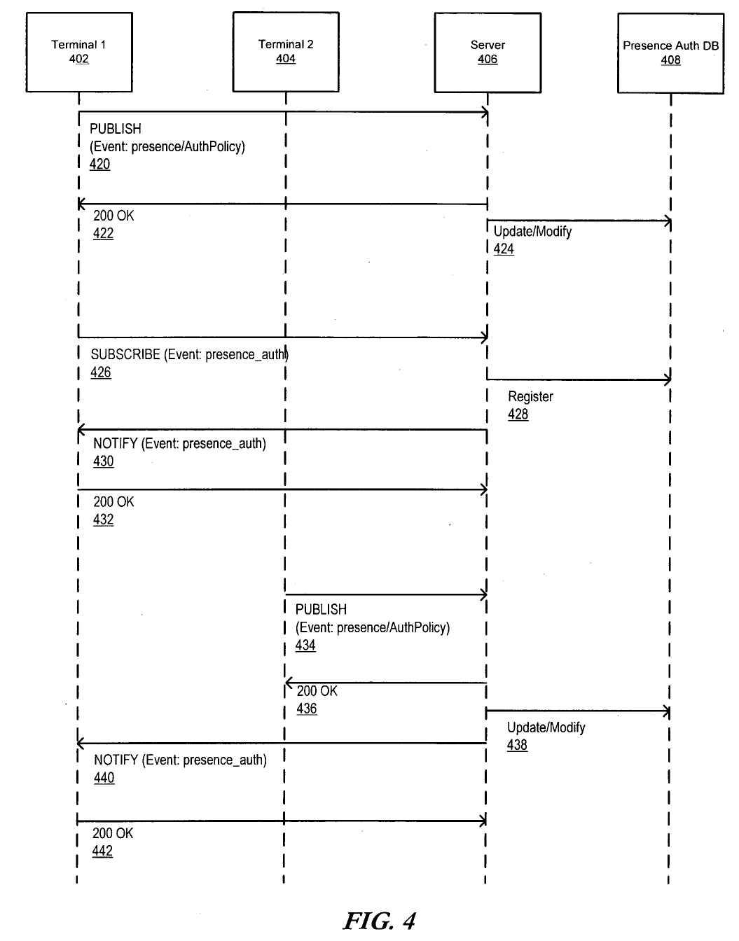

FIG. 4 is a message flow diagram showing persistent data being updated using the PUBLISH method. In this scenario, two terminals 402 and 404 are associated with a common user. A presence authorization server 406 communicates with the terminals 402, 404 and is coupled to an authorization database 408. At event 420, the terminal 402 sends a PUBLISH message to the server 406 to set the authorization data. The authorization data may include member access lists, restriction lists, domain access lists, password authorization, authorization policies, or any other means of allowing and blocking access to the user. The event 420 may be an initialization of the authorization data (e.g. the device was just powered on and connected) or be an update to an existing data set. The server 406 responds with the standard OK message at event 422 and updates the persistent data at event 424.

The terminal 402 may also want to be posted of any changes to the authorization data from other sources, such as terminal 404. This is accomplished at event 426 where terminal 402 sends a SIP SUBSCRIBE message to the server 406. The server 406 may registers this subscription with the database 408 at event 428. The server 406 may alternately register the subscription somewhere besides the authorization database 408, such as a presence database or in memory. The server 406 also sends a NOTIFY message at event 430 to update state on terminal 402 as required when implementing SUBSCRIBE/NOTIFY. The terminal acknowledges the NOTIFY with an OK at event 432.

If changes to authorization policy are made at the terminal 404, the terminal 404 sends the PUBLISH message to the server 406 at event 434. The server 406 acknowledges at with an OK at event 436 and updates the database 403 at event 438. Because terminal 402 has subscribed to changes in the authorization policy, the server 406 sends a NOTIFY message to the terminal 402 at event 440 which is acknowledged with an OK at event 442.

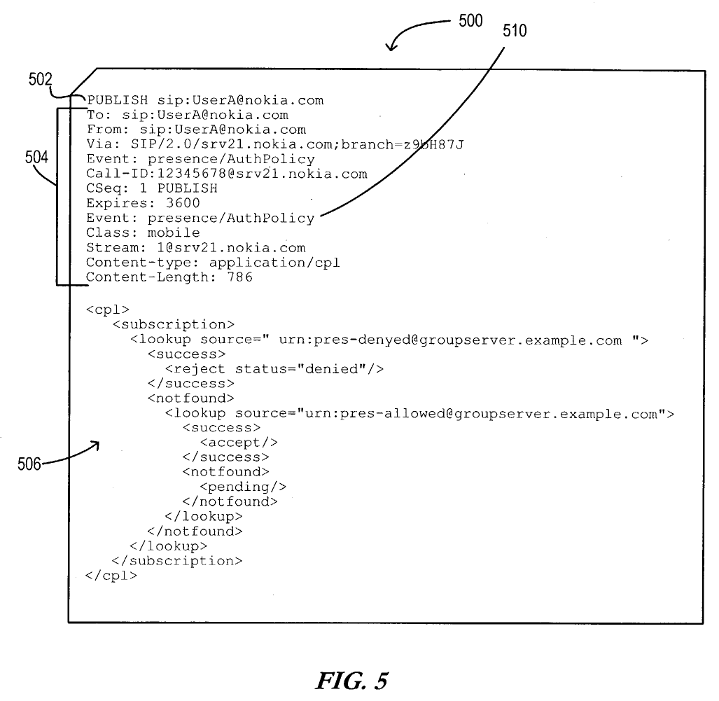

As previously mention with respect to FIG. 2, the SIP message may contain a body portion. In relation to concepts of the present invention, this message body can be used to update persistent data on a processing system. FIG. 5 illustrates an example SIP PUBLISH message containing a body that can be used to update an authorization policy.

The message 500 in FIG. 5 includes the standard start line 502 and header 504. The body 506 includes a processing language (CPL) script formatted in extensible markup language (XML). In this example, the CPL script is used to deny access to “pres-denyed@groupserver.example.com” and grant access to “pres-allowed@groupserver.example.com.

The SIP header allows for various descriptive fields enabling the recipient to properly deal with the message. In the example header 504 of FIG. 5, the Event field 510 indicates that the message is related to presence authorization, and the receiving system can dispatch the message appropriately (e.g. send to presence authorization server). Other SIP defined fields may be used to expand on this function. Such fields as Publish, Binding, Content-Type, Content-Disposition, Class, Stream may be used to described with any desired level of detail the contents of the message and how the persistent data is to be modified.

The message body 506 is shown as XML/CPL for purposes of illustration. It will be readily apparent to those skilled in the art from the description provided herein that the present invention is equally applicable to analogous programming technologies such as Hypertext Markup Language (HTML), remote procedure calls (RPC), binary code, scripts, Java Applets, Common Gateway Interface (CGI) scripts, Simple Object Access Protocol (SOAP), Application Configuration Access Protocol (ACAP), etc., whether existing currently or in the future. The SIP specification allows any sort of binary or text to be contained within the message body, therefore it is appreciated that any manner of message body may be used to update authorization or other persistent data according to the concepts of the present invention. Further, as previously mention with regards to the “Authorization” headers, modification data can be included in whole or in part as SIP header entries.

Using the description provided herein, the invention may be implemented as a machine, process, or article of manufacture by using standard programming and/or engineering techniques to produce programming software, firmware, hardware or any combination thereof. Any resulting program(s), having computer-readable program code, may be embodied on one or more computer-usable media such as resident memory devices, smart cards or other removable memory devices, or transmitting devices, thereby making a computer program product or article of manufacture according to the invention. As such, “computer readable mediums” as used herein are intended to encompass a computer program that exists permanently or temporarily on any computer-usable medium or in any transmitting medium which transmits such a program.

As indicated above, memory/storage devices include, but are not limited to, disks, optical disks, removable memory devices such as smart cards, SIMs, WIMs, semiconductor memories such as RAM, ROM, PROMS, etc. Communication mediums include, but are not limited to, communications via wireless/radio wave communication networks, the Internet, intranets, telephone/modem-based network communication, hard-wired/cabled communication network, satellite communication, and other stationary or mobile network systems/communication links.

From the description provided herein, those skilled in the art are readily able to combine software created as described with appropriate general purpose or special purpose computer hardware to create a data processing device and/or computer subcomponents embodying the invention, and to create a data processing device and/or computer subcomponents for carrying out the method of the invention.

The foregoing description of the exemplary embodiment of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather by the claims appended hereto.

What is claimed is:

1. A method for manipulating an authorization data on a remote data processing device, comprising:
preparing a modification data on a local data processing device;
sending the modification data to the remote data processing device using a session initiation protocol; and
modifying the authorization data with the modification data on the remote data processing device.

2. The method of claim 1, wherein preparing the modification data on the local data processing device comprises using a PUBLISH method of the session initiation protocol (SIP).

3. The method of claim 2, wherein preparing the modification data on the local data processing device comprises describing the modification data using a SIP Event header entry.

4. The method of claim 2, wherein preparing the modification data on the local data processing device comprises describing the modification data using a SIP Content-Disposition header entry.

5. The method of claim 1, wherein preparing the modification data on the local data processing device comprises using a DO method of the session initiation protocol (SIP).

6. The method of claim 1, wherein preparing the modification data on the local data processing device comprises using a PUT method of the session initiation protocol (SIP).

7. The method of claim 1, wherein preparing the modification data on the local data processing device comprises describing the modification data using an Event header entry of the session initiation protocol (SIP).

8. The method of claim 1, wherein preparing the modification data on the local data processing device comprises describing the modification data using a Content-Disposition header entry of the session initiation protocol (SIP).

9. The method of claim 1, wherein the modification data is formatted as extensible markup language (XML).

10. The method of claim 1, wherein the modification data is formatted as call processing language (CPL).

11. The method of claim 1, wherein the modification data is formatted as simple object access protocol (SOAP) language.

12. The method of claim 1, wherein the modification data is formatted as application configuration access protocol (ACAP) language.

13. The method of claim 1, wherein the authorization data comprises one or more access lists.

14. The method of claim 1, wherein the authorization data comprises one or more membership lists.

15. The method of claim 1, wherein the authorization data comprises a presence access policy.

16. A data processing system associated with a network, comprising:
a remote data processing device in connection with the network;
a local data processing device comprising:
a storage device containing an authorization data;
a network interface configured to communicate with the remote data processing device over the network; and
a processor arranged to receive a message from remote data processing device over the network interface using a session initiation protocol and extract a modification data from the message, the processor further configured to modify the authorization data using the modification data.

17. The system of claim 16, wherein the message comprises a PUBLISH method of the session initiation protocol (SIP).

18. The system of claim 16, wherein the message comprises a DO method of the session initiation protocol (SIP).

19. The system of claim 16, wherein the message comprises a PUT method of the session initiation protocol (SIP).

20. The system of claim 16, wherein the processor is further configured to modify the authorization data based on a SIP Event header of the message.

21. The system of claim 16, wherein the processor is further configured to modify the authorization data based on a SIP Content-Disposition header of the message.

22. The system of claim 16, wherein the replacement data is formatted as extensible markup language (XML).

23. The system of claim 16, wherein the replacement data is formatted as call processing language (CPL).

24. The system of claim 16, wherein the replacement data is formatted as simple object access protocol (SOAP) language.

25. The system of claim 16, wherein the replacement data is formatted as application configuration access protocol (ACAP) language.

26. The system of claim 16, wherein the authorization data comprises one or more access lists.

27. The system of claim 16, wherein the authorization data comprises one or more membership lists.

28. The system of claim 16, wherein the authorization data comprises a presence access policy.

29. The system of claim 16, wherein the network comprises a wireless network.

30. The system of claim 29, wherein the remote data processing device comprises a wireless telephone.

31. The system of claim 29, wherein the remote data processing device comprises a personal digital assistant (PDA).

32. A method for manipulating an authorization data on a remote data processing device, comprising:
preparing a session initiation protocol formatted message on a local processing device, the message including a modification data in a message body;
sending the message to the remote data processing device using a session initiation protocol;
examining a content header of the message at the remote data processing device to determine the contents of the message body;
processing the message body based on the content header to extract the modification data from the message body; and
modifying the authorization data with the modification data.

33. The method of claim 32, wherein preparing the message comprises including a PUBLISH method of the session initiation protocol (SIP) in the message.

34. The method of claim 32, wherein examining the content header of the message at the remote data processing device comprises examining a SIP Event header.

35. The method of claim 32, wherein examining the content header of the message at the remote data processing device comprises examining a SIP Content-Disposition header.

36. The method of claim 32, wherein the message body is formatted as extensible markup language (XML).

37. The method of claim 32, wherein the message body is formatted as call processing language (CPL).

38. The method of claim 32, wherein the message body is formatted as simple object access protocol (SOAP) language.

39. The method of claim 32, wherein the message body is formatted as application configuration access protocol (ACAP) language.

40. The method of claim 32, wherein the authorization data comprises one or more access lists.

41. The method of claim 32, wherein the authorization data comprises one or more membership lists.

42. The method of claim 32, wherein the authorization data comprises a presence access policy.
